(19) United States
(12) Patent Application Publication
(10) Pub. No.: US 2026/0238421 A1
(43) Pub. Date: Aug. 13, 2026

(54) METHOD AND APPARATUS FOR CONFIGURING COMMUNICATION SYSTEM

(71) Applicant: BEIJING XIAOMI MOBILE SOFTWARE CO., LTD., Beijing (CN)

(72) Inventors: Gaoming DUAN, Beijing (CN); Liangang CHI, Beijing (CN)

(73) Assignee: BEIJING XIAOMI MOBILE SOFTWARE CO., LTD., Beijing (CN)

(21) Appl. No.: 19/151,540

(22) PCT Filed: Jan. 30, 2023
(86) PCT No.: PCT/CN2023/073906

§ 371 Date: Jul. 28, 2025

(51) Int. Cl. H04L 5/00; H04B 7/06

(52) U.S. Cl. CPC H04L 5/0048; H04B 7/06968; H04L 5/0098

(57) ABSTRACT

A method for configuring a communication system, performed by a network device, including: sending configuration information to a terminal, wherein the configuration information comprises information associated with a transmission reception point (TRP) cluster corresponding to the terminal.

### CROSS-REFERENCE TO RELATED APPLICATIONS

This application is the U.S. national phase application of International Application No. PCT/CN2023/073906 filed on Jan. 30, 2023, the entire contents of which are incorporated herein by reference.

### TECHNICAL FIELD

The disclosure relates to the field of communication technologies, in particular to a method for configuring a communication system, and an apparatus for configuring a communication system.

### BACKGROUND

In a cellular network, when a terminal moves across cells, it generally needs to frequently perform cell handover, and thus the terminal may be disconnected, thereby affecting a communication stability. Moreover, when the terminal is at the edge of a cell, its communication quality is usually poor.

### SUMMARY

According to a first aspect of embodiments of the disclosure, a method for configuring a communication system is provided. The method is performed by a network device, and includes:
sending configuration information to a terminal, in which the configuration information includes information associated with a transmission reception point (TRP) cluster corresponding to the terminal.

According to a second aspect of embodiments of the disclosure, a method for configuring a communication system is provided. The method is performed by a terminal, and includes:
receiving configuration information sent by a network device, in which the configuration information comprises information associated with a TRP cluster corresponding to the terminal.

According to a third aspect of embodiments of the disclosure, a network device is provided. The network device includes: a processor and a memory storing a computer program executable by the processor. The processor is configured to: send configuration information to a terminal, in which the configuration information comprises information associated with a TRP cluster corresponding to the terminal.

According to a fourth aspect of embodiments of the disclosure, a terminal is provided. The terminal includes a processor a memory storing a computer program executable by the processor. The processor is configured to perform the method described in the second aspect.

### BRIEF DESCRIPTION OF THE DRAWINGS

The above-mentioned and/or additional aspects and advantages of the disclosure will be apparent and easily understood from the following description of the embodiments in combination with the accompanying drawings.

FIG. 1 is a structural schematic diagram of a distributed Multiple Input Multiple Output (MIMO) communication system provided by an embodiment of the disclosure.

FIG. 2 is a flowchart of a method for configuring a communication system applicable to a network device provided by an embodiment of the disclosure.

FIG. 3 is a flowchart of a method for configuring a communication system provided by an embodiment of the disclosure.

FIG. 4 is a flowchart of a method for configuring a communication system applicable to a terminal provided by an embodiment of the disclosure.

FIG. 5 is a flowchart of a method for configuring a communication system provided by an embodiment of the disclosure.

FIG. 6 is a structural schematic diagram of a communication apparatus provided by an embodiment of the disclosure.

FIG. 7 is a structural schematic diagram of a communication apparatus provided by an embodiment of the disclosure.

FIG. 8 is a structural schematic diagram of a communication apparatus provided by an embodiment of the disclosure.

FIG. 9 is a structural schematic diagram of a chip provided by an embodiment of the disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the embodiments of the disclosure. Instead, they are merely examples of apparatuses and methods consistent with aspects related to the embodiments of the disclosure as recited in the attached claims.

The terms used in the disclosure are only for the purpose of describing specific embodiments, and are not intended to limit the embodiments of the disclosure. The singular forms of “a” and “the” used in the disclosure and attached claims are also intended to include plural forms, unless the context clearly indicates other meanings. It is understandable that the term “and/or” as used herein refers to and includes any or all possible combinations of one or more associated listed items.

It is understandable that although the terms “first”, “second” and “third” may be used in the embodiments of the disclosure to describe various types of information, the information should not be limited to these terms. These terms are only used to distinguish the same type of information from each other. For example, without departing from the scope of the embodiments of the disclosure, the first information may also be referred to as the second information, and similarly, the second information may also be referred to as the first information. Depending on the context, the term “if” as used herein may be interpreted as “when”, “while” or “in response to determining”.

The embodiments of the disclosure are described in detail below, examples of which are illustrated in the accompanying drawings, in which the same or similar reference numerals refer to the same or similar elements throughout. The embodiments described below with reference to the accompanying drawings are exemplary and are intended to be used to explain the disclosure, but should not be construed as limiting the disclosure.

For easy of understanding, terms involved in the disclosure are introduced first.

### 1. TRP (Transmission Reception Point)

The TRP is configured to perform data transmission or reception of the terminal.

### 2. Centralized Unit (CU)

A CU is configured to execute computer instructions or work with a monitoring client unit of a ClientUnit monitoring system. The CU is responsible for process management of a program. Generally, the CU is connected with a plurality of TRPs and aggregates information from each of the TRPs, to coordinate and schedule radio resources. Different CUs exchange information through an optical fiber, a core network or a radio interface.

FIG. 1 is a structural schematic diagram of a distributed multi-user MIMO communication system provided by an embodiment of the disclosure. The communication system includes at least one TRP and at least one terminal. The number and form of devices shown in FIG. 1 are only for examples and do not constitute a limitation on the embodiments of the disclosure, and one or more TRPs and one or more terminals may be included in practical applications. The communication system shown in FIG. 1 includes, for example, fifteen TRPs and one terminal.

The terminal in the embodiments of the disclosure is an entity on a user side for receiving or transmitting signals, such as a cellular phone. The terminal may also be referred to as a terminal device, a user equipment (UE), a mobile station (MS), a mobile terminal (MT), and the like. The terminal may be a car with communication functions, a smart car, a mobile phone, a wearable device, a Pad, a computer with wireless transceiver functions, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. The specific technology and specific device form adopted by the terminal are not limited in the embodiments of the disclosure.

In an embodiment of the disclosure, the terminal may correspond to a TRP cluster. The TRP cluster may include at least one TRP, and some or all of the TRP in the TRP cluster corresponding to the terminal may be used to provide communication services for the terminal. In an embodiment of the disclosure, the TRP cluster corresponding to the terminal may be subjected to a cluster handover, or the TRP included in the TRP cluster corresponding to the terminal may be changed dynamically.

In an embodiment of the disclosure, the TRP cluster corresponding to the terminal may be subjected to the cluster handover, i.e., the TRP cluster corresponding to the terminal is handed over from the current TRP cluster to another TRP cluster, which indicates that a cluster Identity (ID) of the TRP cluster corresponding to the terminal has changed. In an embodiment of the disclosure, assuming that at a first timing, the TRP cluster corresponding to the terminal is TRP cluster #1, and at a second timing, the TRP cluster corresponding to the terminal is changed to TRP cluster #2, and thus it is considered that the TRP cluster corresponding to the terminal has been subjected to the cluster handover from the first timing to the second timing.

In an embodiment of the disclosure, the TRP included in the TRP cluster corresponding to the terminal may be changed dynamically, i.e., the cluster ID of the TRP cluster corresponding to the terminal remains the same, but the TRP included in the TRP cluster corresponding to the terminal is changed dynamically. In an embodiment of the disclosure, the TRP cluster corresponding to the terminal is TRP cluster #1 at the first timing, and the TRP included in the TRP cluster #1 at the first timing are TRP #1, TRP #2 and TRP #3. At the second timing, the TRP cluster corresponding to the terminal is still TRP cluster #1, but the TRP included in the TRP cluster #1 is changed to TRP #4, TRP #2 and TRP #3, so it is considered that from the first timing to the second timing, the TRP included in the TRP cluster corresponding to the terminal is changed dynamically.

In an embodiment of the disclosure, as illustrated in FIG. 1, regardless of whether the terminal is at location A or location B, the TRP cluster corresponding to the terminal is TRP cluster #1, but the TRP included in the TRP cluster #1 corresponding to the terminal at location A is different from that included in the TRP cluster #1 corresponding to the terminal at location B, so it is considered that the TRP included in the corresponding TRP cluster is changed dynamically when the terminal moves from location A to location B. As another example, when the terminal is at location B, the corresponding TRP cluster is TRP cluster #1, and when it is at location C, the corresponding TRP cluster is TRP cluster #2, so it is considered that the corresponding TRP cluster has been subjected to the cluster handover when the terminal moves from location B to location C.

It should be noted that the TRP cluster here is only a name provided by the solutions for description, and it can also be referred to by other names, which is not limited by the disclosure. Moreover, the above-mentioned cluster ID may be a unique ID of a TRP cluster, and the TRP cluster may also be identified by other representations, which is not limited by the disclosure.

In an embodiment of the disclosure, at a time, the terminal only corresponds to one TRP cluster, and the terminal corresponds to different TRP clusters at different times (i.e., the TRP cluster corresponding to the terminal is subjected to the cluster handover). Or, at different times, the terminal may correspond to the same TRP cluster, but the TRP included in the TRP cluster are different (i.e., the TRP included in the TRP cluster corresponding to the terminal is changed dynamically).

In an embodiment of the disclosure, the TRP cluster corresponding to the terminal may be subjected to the cluster handover, which includes at least one of:
as the terminal moves, the network device schedules the TRP cluster corresponding to the terminal to be subjected to the cluster handover;
as a channel condition of the terminal changes, the network device schedules the TRP cluster corresponding to the terminal to be subjected to the cluster handover; or
as a service requirement of the terminal changes, the network device schedules the TRP cluster corresponding to the terminal to be subjected to the cluster handover.

In an embodiment of the disclosure, the TRP included in the TRP cluster corresponding to the terminal is changed dynamically, which includes at least one of the following:
as the terminal moves, the network device schedules the TRP included in the TRP cluster corresponding to the terminal to be dynamically changed;
as a channel condition of the terminal changes, the network device schedules the TRP included in the TRP cluster corresponding to the terminal to be dynamically changed; or
as a service requirement of the terminal changes, the network device schedules the TRP included in the TRP cluster corresponding to the terminal to be dynamically changed.

In an embodiment of the disclosure, the network device in the embodiments of the disclosure is an entity on a network side for transmitting or receiving signals. The network device may be an evolved NodeB (eNB), a TRP, an Radio Remote Head (RRH), a next generation NodeB (gNB) in a New Radio (NR) system, a base station in other future mobile communication systems or an access node in a wireless fidelity (Wi-Fi) system. The specific technology and specific device form adopted by the network device are not limited in the embodiments of the disclosure. The network device in the embodiments of the disclosure may be composed of a central unit (CU) and a distributed unit (DU). The CU may also be called control unit or centralized unit. The use of CU-DU structure allows to divide a protocol layer of the network device, such as a base station, such that some of the protocol layer functions are placed in the CU for centralized control, and some or all of the remaining protocol layer functions are distributed in the DU, and the DU is centrally controlled by the CU.

In an embodiment of the disclosure, the above-mentioned “as the terminal moves, the network device schedules the TRP cluster corresponding to the terminal to be subjected to the cluster handover or the network device schedules the TRP included in the TRP cluster corresponding to the terminal to be dynamically changed” includes: as the terminal moves, the network device schedules the TRP cluster corresponding to the terminal to be subjected to the cluster handover, or schedules the TRP included in the TRP cluster corresponding to the terminal to be dynamically changed, based on a TRP with better communication quality around the terminal. For example, the network device may schedule the terminal to be handed over to a TRP cluster to which the TRP with better communication quality around the terminal belongs, or the network device may schedule the TRP with better communication quality around the terminal to the TRP cluster corresponding to the terminal. In an embodiment of the disclosure, the above-mentioned TRP with better communication quality around the terminal may be determined by the network device based on a report from the terminal. In an embodiment of the disclosure, the terminal will measure reference signals sent by its surrounding TRPs to obtain a measurement result, and then will send the measurement result to the network device, so that the network device may determine the TRP with better communication quality around the terminal based on the measurement result sent by the terminal.

In an embodiment of the disclosure, the above-mentioned “as a channel condition of the terminal changes, the network device schedules the TRP cluster corresponding to the terminal to be subjected to the cluster handover or the network device schedules the TRP included in the TRP cluster corresponding to the terminal to be dynamically changed” includes: the network device schedules the TRP cluster corresponding to the terminal to be subjected to the cluster handover or the network device schedules the TRP included in the TRP cluster corresponding to the terminal to be dynamically changed, based on a channel condition between each TRP and the terminal. For example, the network device may schedule the terminal to be handed over to a TRP cluster to which a TRP with the better channel condition belongs, or the network device may schedule the TRP with the better channel condition to the TRP cluster corresponding to the terminal. In an embodiment of the disclosure, the TRP with the better channel condition may be determined by the network device based on a report from the terminal. In an embodiment of the disclosure, the terminal will measure reference signals sent by its surrounding TRPs to obtain a measurement result, and then send the measurement result to the network device, so that the network device may determine the TRP with the better channel condition based on the measurement result sent by the terminal.

In an embodiment of the disclosure, the above-mentioned “as a service requirement of the terminal changes, the network device schedules the TRP cluster corresponding to the terminal to be subjected to the cluster handover or the network device schedules the TRP included in the TRP cluster corresponding to the terminal to be dynamically changed” includes: the network device schedules the TRP cluster corresponding to the terminal to be subjected to the cluster handover or the network device schedules the TRP included in the TRP cluster corresponding to the terminal to be dynamically changed, based on a current service requirement of the terminal. The service requirement may be a communication quality requirement or a communication rate requirement, and different services correspond to different service requirements. For example, when the current service requirement (such as the communication rate requirement) of the terminal is high, the network device may schedule more TRPs to the TRP cluster corresponding to the terminal, or the network device may schedule the terminal to be handed over to a TRP cluster containing more TRPs. When the current service requirement (such as the communication rate requirement) of the terminal is low, in order to save resources, the network device may schedule some TRPs to be removed from the TRP cluster corresponding to the terminal, or the network device may schedule the terminal to be handed over to a TRP cluster containing less TRPs.

In an embodiment of the disclosure, when the network device determines that there are many TRPs in the TRP cluster corresponding to the terminal need to be changed dynamically based on at least one of the terminal's mobile location, the terminal's channel condition or the terminal's service requirement, it may directly determines to perform cluster handover for the TRP cluster corresponding to the terminal, such that the TRP cluster after being handed over includes the TRPs that are needed. When the network device determines that only a few TRPs in the TRP cluster corresponding to the terminal need to be changed dynamically based on at least one of the terminal's mobile location, the terminal's channel condition or the terminal's service requirement, the terminal may directly determine to dynamically change the TRP included in the TRP cluster corresponding to the terminal rather than performing cluster handover for the TRP cluster corresponding to the terminal.

In an embodiment of the disclosure, when the network device determines that the TRP cluster corresponding to the terminal is subjected to the cluster handover, the network device may send first configuration information to the terminal. The first configuration information may be information associated with a TRP cluster after handover. In an embodiment of the disclosure, the first configuration information may be used to configure an available communication resource of the TRP cluster after handover to the terminal, so that the terminal may communicate with the TRP in the TRP cluster after handover based on the first configuration information, to complete certain services.

In an embodiment of the disclosure, the first configuration information includes at least one of:
a cluster ID of a TRP cluster after handover;
a TRP ID of a TRP included in the TRP cluster after handover;
a Quasi Co-location (QCL) relationship between antenna ports in the TRP cluster after handover;
reference signal configuration information corresponding to the TRP included in the TRP cluster after handover;
radio resource information corresponding to the TRP included in the TRP cluster after handover; or
first beam indication information, in which the first beam indication information indicates beams of uplink and downlink service channels of a TRP that provides a communication service for the terminal in the TRP cluster after handover.

In an embodiment of the disclosure, the terminal may determine a numeric count of TRPs included in the TRP cluster after handover based on the TRP ID of the TRP included in the TRP cluster and/or a QCL relationship between antenna ports in the TRP cluster, and the numeric count of TRPs included in the TRP cluster after handover may be used for subsequent operations. In an embodiment of the disclosure, the QCL relationship between antenna ports in the TRP cluster may include a QCL relationship between different antenna ports of the same TRP in the TRP cluster and/or a QCL relationship between antenna ports of different TRPs in the TRP cluster. In an embodiment of the disclosure, a numeric count of QCL relationships between antenna ports in the TRP cluster may implicitly indicate the numeric count of TRPs included in the TRP cluster.

In an embodiment of the disclosure, the above-mentioned reference signal configuration information may include a reference signal measurement configuration and/or a reference signal reporting configuration. In an embodiment of the disclosure, the reference signal measurement configuration may be used to indicate a time domain resource occupied by a reference signal corresponding to a TRP, and a parameter measured by the terminal for the reference signal (such as a Reference Signal Received Power (RSRP), and/or a Reference Signal Received Quality (RSRQ)), so that the terminal may receive and measure the reference signal corresponding to the TRP on the corresponding time domain resource based on the measurement configuration. The above-mentioned reference signal reporting configuration may be used to indicate a way for the terminal to report the reference signal measurement result corresponding to the TRP, such as a time domain resource used for reporting, so that the terminal may send the measurement result to the network device based on the reporting configuration, and the network device may schedule the TRP with higher communication quality based on the measurement result to provide communication services for the terminal.

In an embodiment of the disclosure, the radio resource information includes at least one of:
a radio resource frequency band;
a radio resource frequency point;
a radio resource bandwidth; or
a radio resource usage time.

In an embodiment of the disclosure, the first beam indication information includes at least one of:
a beam index; or
a Transmission Configuration Indicator (TCI) state ID.

In an embodiment of the disclosure, when the network device determines that the TRP included in the TRP cluster corresponding to the terminal is changed dynamically, the network device may send second configuration information to the terminal. The second configuration information may be information associated with the TRP that is changed in the TRP cluster corresponding to the terminal. In an embodiment of the disclosure, the second configuration information may be used to configure an available communication resource corresponding to the TRP that is changed dynamically to the terminal, so that the terminal may communicate with the TRP that is changed dynamically based on the second configuration information, in order to complete certain services.

In an embodiment of the disclosure, the second configuration information includes at least one of:
a cluster ID of the TRP cluster corresponding to the terminal;
a TRP ID of the TRP that has been changed;
a QCL relationship between antenna ports in the TRP cluster after the dynamic change;
reference signal configuration information corresponding to the TRP that has been changed;
radio resource information corresponding to the TRP that has been changed; or second beam indication information, in which the second beam indication information indicates beams of uplink and downlink service channels of a TRP that provides a communication service for the terminal in the TRP that has been changed.

Related descriptions of the TRP ID, the QCL relationship, the reference signal configuration information and the radio resource information can refer to the above contents.

In an embodiment of the disclosure, the second beam indication information includes at least one of:
a beam index; or
a TCI state ID.

As can be seen from the above contents, in an embodiment of the disclosure, when the TRP cluster corresponding to the terminal is subjected to the cluster handover, or when the TRP included in the TRP cluster corresponding to the terminal is changed dynamically, the network device will send the first configuration information or the second configuration information to the terminal, so that the terminal may determine the communication resource corresponding to the TRP cluster after handover or the TRP that is changed dynamically, based on the first configuration information or the second configuration information, thereby the terminal can successfully communicate, based on the resource, with the TRP cluster after handover or the TRP that is changed dynamically, in order to complete certain services, which ensures the communication stability.

In an embodiment of the disclosure, as illustrated in FIG. 1, the communication system may include at least one CU, which may be used to schedule the TRP to provide communication services for the terminal. One TRP may be scheduled by at least two CUs.

In an embodiment of the disclosure, as illustrated in FIG. 1, the distributed MIMO communication system includes two CUs. In FIG. 1, the CU being connected to a certain TRP by a line indicates that the CU can schedule the TRP.

In an embodiment of the disclosure, as illustrated in FIG. 1, the communication system may also include a Core Network (CN). Different CUs may communicate with each other through the CN or through an optical fiber or a radio interface.

In conclusion, in the distributed MIMO communication system provided by the embodiment of the disclosure, the terminal corresponds to the TRP cluster containing at least one TRP, and part or all of the TRPs in the TRP cluster corresponding to the terminal are used to provide communication services for the terminal. The TRP cluster corresponding to the terminal may be subjected to the cluster handover, or the TRP included in the TRP cluster corresponding to the terminal may be changed dynamically. Through performing handover for the TRP cluster corresponding to the terminal in real time or changing the TRP in the TRP cluster corresponding to the terminal in real time, the network device can always select the TRP being most beneficial (i.e., having better communication quality) for the terminal to provide communication services for the terminal, thus ensuring the communication quality. Moreover, in the disclosure, the TRP cluster corresponding to the terminal can be subjected to the cluster handover, or the TRP included in the TRP cluster corresponding to the terminal can be changed dynamically. When the terminal moves, the network device can still realize real-time communication with the terminal by performing handover for the TRP cluster corresponding to the terminal, or by dynamically changing the TRP in the TRP cluster corresponding to the terminal, without frequent cell handovers. This solves the problem of disconnection due to the frequent cell handovers, thereby ensuring the communication stability.

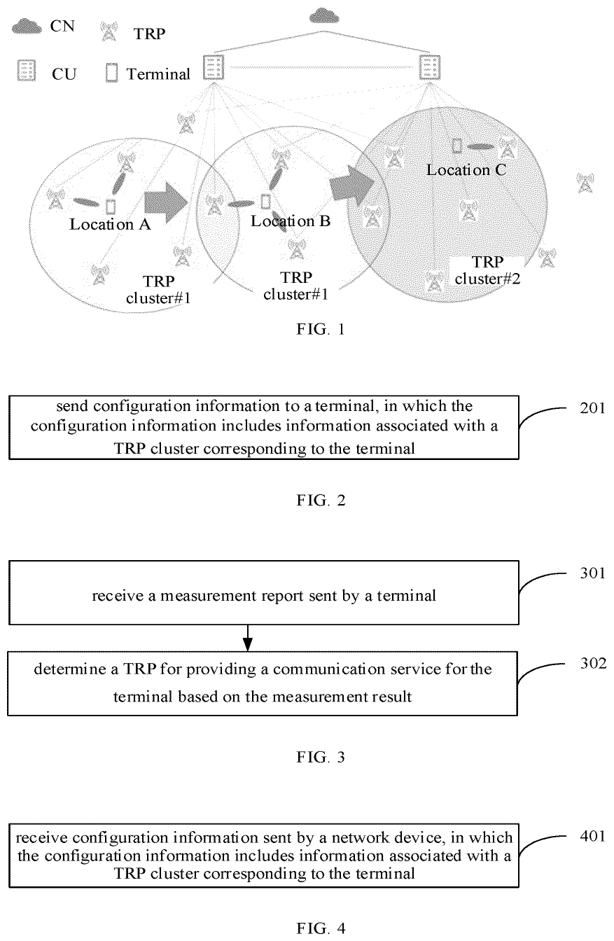

FIG. 2 is a flowchart of a configuration method provided by an embodiment of the disclosure. The configuration method is applied to the distributed MIMO communication system shown in FIG. 1 and is performed by a network device. As illustrated in FIG. 2, the configuration method may include the following steps.

At step 201, configuration information is sent to a terminal, in which the configuration information includes information associated with a TRP cluster corresponding to the terminal.

In an embodiment of the disclosure, the network device includes at least one of:
a TRP;
a centralized unit; or
a core network device.

In an embodiment of the disclosure, sending the configuration information to the terminal includes at least one of:
in response to the TRP cluster corresponding to the terminal being subjected to a cluster handover, sending the configuration information to the terminal; or
in response to a TRP included in the TRP cluster corresponding to the terminal being changed dynamically, sending the configuration information to the terminal.

In an embodiment of the disclosure, the network device may determine whether the TRP cluster corresponding to the terminal is subjected to the cluster handover, or the network device may determine whether the TRP included in the TRP cluster corresponding to the terminal is changed dynamically. The network device sends configuration information to the terminal according to the determined result. In an embodiment of the disclosure, the network device may determine whether the TRP cluster corresponding to the terminal is to be subjected to the cluster handover or whether the TRP included in the TRP cluster corresponding to the terminal is to be dynamically changed based on the terminal's mobile location, the terminal's channel condition and the terminal's service requirement, and the detailed description of this section may be illustrated with reference to the aforementioned embodiments.

In an embodiment of the disclosure, when the network device determines that the TRP cluster corresponding to the terminal is subjected to the cluster handover, it may send configuration information to the terminal, which may be information associated with the TRP cluster after handover. In an embodiment of the disclosure, the configuration information may be used to configure an available communication resource of the TRP cluster after handover to the terminal, so that the terminal may communicate with the TRP in the TRP cluster after handover based on the configuration information, in order to complete certain services. In an embodiment of the disclosure, the configuration information includes at least one of:
a cluster ID of a TRP cluster after handover;
a TRP ID of a TRP included in the TRP cluster after handover;
a QCL relationship between antenna ports in the TRP cluster after handover;
reference signal configuration information corresponding to the TRP included in the TRP cluster after handover;
   radio resource information corresponding to the TRP included in the TRP cluster after handover; or
   first beam indication information, in which the first beam indication information indicates beams of uplink and downlink service channels of a TRP that provides a communication service for the terminal in the TRP cluster after handover.

In an embodiment of the disclosure, when the TRP included in the TRP cluster corresponding to the terminal that is changed dynamically, the network device may send configuration information to the terminal, which may be information associated with the TRP that is changed dynamically. In an embodiment of the disclosure, the configuration information may be used to configure available an communication resource for the TRP that is changed dynamically, so that the terminal may communicate with the TRP that is changed dynamically based on the configuration information, to complete certain services. In an embodiment of the disclosure, the configuration information includes at least one of:
a cluster ID of the TRP cluster corresponding to the terminal;
a TRP ID of the TRP that has been changed;
a QCL relationship between antenna ports in the TRP cluster after the dynamic change;
reference signal configuration information corresponding to the TRP that has been changed;
radio resource information corresponding to the TRP that has been changed; or
second beam indication information, in which the second beam indication information indicates beams of uplink and downlink service channels of a TRP that provides a communication service for the terminal in the TRP that has been changed.

Detailed descriptions of the configuration information may be described with reference to the foregoing embodiments, which will not be repeated in the disclosure.

In conclusion, in the configuration methods provided by the embodiments of the disclosure, the configuration information sent by the network device to the terminal includes the information associated with the TRP cluster corresponding to the terminal, so that the terminal can successfully communicate with the TRP cluster corresponding to the terminal based on the configuration information, to complete certain services, thus ensuring the communication stability.

In the disclosure, the configuration information can be sent to the terminal by the network device when the TRP cluster corresponding to the terminal is subjected to the cluster handover, or the configuration information can be sent to the terminal by the network device when the TRP included in the TRP cluster corresponding to the terminal is changed dynamically. Therefore, in the disclosure, the TRP cluster corresponding to the terminal may be subjected to the cluster handover, or the TRP included in the TRP cluster corresponding to the terminal may be changed dynamically. Through performing handover for the TRP cluster corresponding to the terminal in real time or changing the TRP in the TRP cluster corresponding to the terminal in real time, the network device can always select the TRP being most beneficial (i.e., having better communication quality) for the terminal to provide communication services for the terminal, thus ensuring the communication quality. Moreover, in the disclosure, the TRP cluster corresponding to the terminal can be subjected to the cluster handover, or the TRP included in the TRP cluster corresponding to the terminal can be changed dynamically. When the terminal moves, the network device can still realize real-time communication with the terminal by performing handover for the TRP cluster corresponding to the terminal, or by dynamically changing the TRP in the TRP cluster corresponding to the terminal, without frequent cell handovers. This solves the problem of disconnection due to the frequent cell handovers, thereby ensuring the communication stability.

FIG. 3 is a flowchart of a configuration method provided by an embodiment of the disclosure. The configuration method is applied to the distributed MIMO communication system shown in FIG. 1 and is performed by a network device. As illustrated in FIG. 3, the configuration method may include the following steps.

At step 301, a measurement result sent by a terminal is received.

In an embodiment of the disclosure, the measurement result may be obtained by measuring a reference signal sent by the terminal. The TRP corresponding to the measured reference signal may be a TRP surrounding the terminal. In an embodiment of the disclosure, the TRP may or may not be included in the TRP cluster corresponding to the terminal. For example, the terminal may measure it according to configuration information sent by the network device.

At step 302, a TRP for providing a communication service for the terminal is determined based on the measurement result.

In an embodiment of the disclosure, the network device may determine to specifically schedule which TRP cluster to be handed over for the terminal based on the measurement result, and after the terminal is handed over to the TRP cluster, the network device determines which TRP is used to provide the communication service for the terminal from the TRP cluster after handover based on the measurement result. Or, in an embodiment of the disclosure, the network device may determine, based on the measurement result, to dynamically schedule which TRP to be added into the TRP cluster corresponding to the terminal and/or to dynamically schedule which TRP to be removed from the TRP cluster corresponding to the terminal.

In an embodiment of the disclosure, the network device may schedule the terminal to be handed over to the TRP cluster to which the TRP with better measurement result belongs, and after the terminal is handed over to the corresponding TRP cluster, the network device may schedule the TRP with better measurement result in the TRP cluster to provide the communication service for the terminal. Or, in an embodiment of the disclosure, based on the measurement result, the network device may schedule a TRP, that does not belong to the TRP cluster corresponding to the terminal and has a better measurement result, to be added into the TRP cluster corresponding to the terminal, and/or may schedule a TRP with poor measurement result to be removed from the TRP cluster corresponding to the terminal.

In conclusion, in the configuration methods provided by the embodiments of the disclosure, the network device may determine the TRP for providing a communication service for the terminal based on the measurement result sent by the terminal, to be able to always select the TRP being most beneficial (i.e., having better communication quality) for the terminal to provide communication services for the terminal, thus ensuring the communication quality.

FIG. 4 is a flowchart of a configuration method provided by an embodiment of the disclosure. The configuration method is applied to the distributed MIMO communication system shown in FIG. 1 and is performed by a terminal. As illustrated in FIG. 4, the configuration method may include the following steps.

At step 401, configuration information sent by a network device is received, in which the configuration information includes information associated with a TRP cluster corresponding to the terminal.

In an embodiment of the disclosure, when the TRP cluster corresponding to the terminal is subjected to the cluster handover, and/or when the TRP included in the TRP cluster corresponding to the terminal is changed dynamically, the terminal may receive the configuration information sent by the network device.

In an embodiment of the disclosure, when the TRP cluster corresponding to the terminal is subjected to the cluster handover, the configuration information may be information associated with a TRP cluster after handover. In an embodiment of the disclosure, the configuration information may be used to configure an available communication resource of the TRP cluster after handover to the terminal, so that the terminal may communicate with the TRP in the TRP cluster after handover based on the configuration information, to complete certain services. In an embodiment of the disclosure, the configuration information includes at least one of:
a cluster ID of a TRP cluster after handover corresponding to the terminal;
a TRP ID of a TRP included in the TRP cluster after handover corresponding to the terminal;
a QCL relationship between antenna ports in the TRP cluster after handover corresponding to the terminal;
reference signal configuration information corresponding to the TRP included in the TRP cluster after handover corresponding to the terminal;
radio resource information corresponding to the TRP included in the TRP cluster after handover corresponding to the terminal; or
first beam indication information, in which the first beam indication information indicates beams of uplink and downlink service channels of a TRP that provides a communication service for the terminal in the TRP cluster after handover corresponding to the terminal.

In an embodiment of the disclosure, when the TRP included in the TRP cluster corresponding to the terminal is changed dynamically, the configuration information may be information associated with the TRP that is changed dynamically. In an embodiment of the disclosure, the configuration information may be used to configure an available communication resource for the TRP that is changed dynamically to the terminal, so that the terminal may communicate with the TRP that is changed dynamically based on the configuration information, to complete certain services. In an embodiment of the disclosure, the configuration information includes at least one of:
a cluster ID of the TRP cluster corresponding to the terminal;
a TRP ID of the TRP that has been changed in the TRP cluster corresponding to the terminal;
a QCL relationship between antenna ports in the TRP cluster after the dynamic change;
reference signal configuration information corresponding to the TRP that has been changed in the TRP cluster corresponding to the terminal;
radio resource information corresponding to the TRP that has been changed in the TRP cluster corresponding to the terminal; or
second beam indication information, in which the second beam indication information indicates beams of uplink and downlink service channels of a TRP that provides a communication service for the terminal in the TRP that has been changed in the TRP cluster corresponding to the terminal.

The detailed descriptions of step 401 can be illustrated with reference to the above embodiments.

In conclusion, in the configuration methods provided by the embodiments of the disclosure, the configuration information sent by the network device to the terminal includes information associated with the TRP cluster corresponding to the terminal, so that the terminal can successfully communicate with the TRP cluster corresponding to the terminal based on the configuration information to complete certain services, thus ensuring the communication stability.

In the disclosure, the network device sends the configuration information to the terminal when the TRP cluster corresponding to the terminal is subjected to the cluster handover, or the network device sends the configuration information to the terminal when the TRP included in the TRP cluster corresponding to the terminal is changed dynamically. Therefore, in the disclosure, the TRP cluster corresponding to the terminal may be subjected to the cluster handover, or the TRP included in the TRP cluster corresponding to the terminal may be changed dynamically. Through performing handover for the TRP cluster corresponding to the terminal in real time or changing the TRP in the TRP cluster corresponding to the terminal in real time, the network device can always select the TRP being most beneficial (i.e., having better communication quality) for the terminal to provide communication services for the terminal, thus ensuring the communication quality. Moreover, in the disclosure, the TRP cluster corresponding to the terminal can be subjected to the cluster handover, or the TRP included in the TRP cluster corresponding to the terminal can be changed dynamically. When the terminal moves, the network device can still realize real-time communication with the terminal by performing handover for the TRP cluster corresponding to the terminal, or by dynamically changing the TRP in the TRP cluster corresponding to the terminal, without frequent cell handovers. This solves the problem of disconnection due to the frequent cell handovers, thereby ensuring the communication stability.

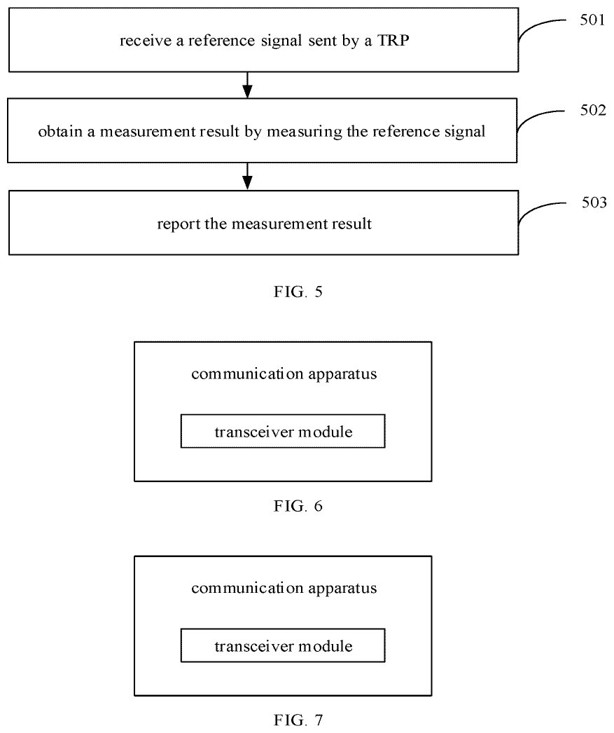

FIG. 5 is a flowchart of a configuration method provided by an embodiment of the disclosure. The configuration method is applied to the distributed MIMO communication system shown in FIG. 1 and is performed by a terminal. As illustrated in FIG. 5, the configuration method may include the following steps.

At step 501, a reference signal sent by a TRP is received.

In an embodiment of the disclosure, the terminal may receive a reference signal sent by a TRP surrounding the terminal. In an embodiment, the TRP may or may not be included in the TRP cluster corresponding to the terminal.

In an embodiment of the disclosure, the terminal may receive the reference signal sent by the TRP and then receive configuration information sent by the network device. Or, the terminal may receive the configuration information sent by the network device before receiving the reference signal sent by the TRP. Or, the terminal may receive the reference signal sent by the TRP and the configuration information sent by the network device simultaneously.

At step 502, a measurement result is obtained by measuring the reference signal.

The terminal may evaluate a channel quality between the terminal and the TRP by measuring the reference signal sent by the TRP. In an embodiment of the disclosure, the terminal may receive and measure the reference signal sent by the TRP based on a measurement configuration in reference signal configuration information sent by the network device.

At step 503, the measurement result is reported.

In an embodiment of the disclosure, the terminal may send the measurement result based on a reporting configuration in the reference signal configuration information sent by the network device.

In addition, the detailed descriptions of steps 501-503 may be illustrated with reference to the descriptions of the above embodiments.

In conclusion, in the configuration methods provided by the embodiments of the disclosure, the terminal sends the measurement result of the reference signal sent by the TRP to the network device, so that the network device can determine the TRP that provides a communication service for the terminal based on the measurement result sent by the terminal, to select the TRP being most beneficial (i.e., having better communication quality) for the terminal to provide communication services for the terminal, thus ensuring the communication quality.

The communication system of the disclosure will be introduced below by way of example.

The network architecture is shown in FIG. 1 above, and each part is defined as follows.

TRP: the TRP is used for data transmission or reception of the terminal.

CU: the CU is generally connected to a plurality of TRPs through optical fibers, and aggregates information from each of the TRPs to a central controller to coordinate and schedule radio resources. Different CUs exchange information through an optical fiber or a CN.

TRP cluster: the TRP cluster is a group composed of multiple TRPs configured by the network for the terminal, the TRP cluster is specific for the terminal, and some or all TRPs in the TRP cluster participate in data transmission.

As illustrated in FIG. 1, the network may configure a unique TRP cluster for each terminal, and each terminal may only connect to one TRP cluster at a timing. The TRP used for data transmission of the terminal may be selected from the TRP cluster, and the TRP that provides services for the terminal may be indicated implicitly through a TCI instead of being directly indicated to the terminal.

As the terminal moves, a channel condition changes, as well as a numeric count of TRPs included in the TRP cluster corresponding to the terminal changes, the TRP cluster corresponding to the terminal may be changed. The same TRP may be connected to multiple CUs. When the TRP cluster is updated (that is, the TRP included in the TRP cluster corresponding to the terminal is changed dynamically) or handed over, the network sends the configuration information to inform the terminal. The details are provided as follows.

### Network Side

1. When the TRP cluster corresponding to the terminal is changed (i.e., when the TRP cluster is handed over), the network configures TRP cluster information for the terminal. The configuration information includes at least one of:
   a) TRP cluster ID;
   B) a TRP ID of a TRP included in the TRP cluster;
   C) reference signal configuration information of the TRP cluster;
   D) radio resource information, including at least one of:
   i. a frequency band or a frequency point;
   ii. a bandwidth; or
   iii. a time;
   E) beam indication information of uplink and downlink service channels, including at least one of:
   i. a beam index; or
   ii. a TCI state ID.
2. when a configuration of the TRP cluster is updated, the TRP included in the TRP cluster is updated (which refers to that the TRP included in the TRP cluster is changed dynamically). The configuration information may be one of the following:
   a) the configuration information including all of above section 1 (which is applicable to a scenario where many TRPs are changed); and
   b) the configuration information including some of above section 1 (which is applicable to a scenario where only a few TRPs are changed).

### Terminal Side

1. When the configuration information from the network side is received,
   a reference signal sent by a TRP in the TRP cluster is received, a channel quality is evaluated, and reporting is completed according to the network configuration.

The network architecture disclosed in the disclosure can realize consistent coverage. When the terminal moves, the TRP cluster corresponding to the terminal is updated quickly to prevent the terminal from disconnecting. When the channel quality between the TRP that provides services for the terminal and the terminal is poor, the network may schedule and perform handover to another TRP in the TRP cluster through a control signaling, to provide services for the terminal, which ensures a link quality and reduces a switch delay. Therefore, the network architecture solves the problem of frequent cell handovers in the current cellular network and the problem of disconnection due to handover.

FIG. 6 is a structural schematic diagram of a communication apparatus provided by an embodiment of the disclosure. As illustrated in FIG. 6, the apparatus includes:
a transceiver module, configured to send configuration information to a terminal, in which the configuration information includes information associated with a TRP cluster corresponding to the terminal.

In conclusion, in the communication apparatus provided by the embodiment of the disclosure, the configuration information sent by the network device to the terminal includes information associated with the TRP cluster corresponding to the terminal, so that the terminal can successfully communicate with the TRP cluster corresponding to the terminal based on the configuration information to complete certain services, thereby ensuring the communication stability.

In the disclosure, the network device sends the configuration information to the terminal when the TRP cluster corresponding to the terminal is subjected to the cluster handover, or the network device sends the configuration information to the terminal when a TRP included in the TRP cluster corresponding to the terminal is changed dynamically. Therefore, in the disclosure, the TRP cluster corresponding to the terminal may be subjected to the cluster handover, or the TRP included in the TRP cluster corresponding to the terminal may be changed dynamically. Through performing handover for the TRP cluster corresponding to the terminal in real time or changing the TRP in the TRP cluster corresponding to the terminal in real time, the network device can always select the TRP being most beneficial (i.e., having better communication quality) for the terminal to provide communication services for the terminal, thus ensuring the communication quality. Moreover, in the disclosure, the TRP cluster corresponding to the terminal can be subjected to the cluster handover, or the TRP included in the TRP cluster corresponding to the terminal can be changed dynamically. When the terminal moves, the network device can still realize real-time communication with the terminal by performing handover for the TRP cluster corresponding to the terminal, or by dynamically changing the TRP in the TRP cluster corresponding to the terminal, without frequent cell handovers. This solves the problem of disconnection due to the frequent cell handovers, thereby ensuring the communication stability.

In an embodiment of the disclosure, sending the configuration information to the terminal includes at least one of:
in response to the TRP cluster corresponding to the terminal being subjected to the cluster handover, sending the configuration information to the terminal; or
in response to a TRP included in the TRP cluster corresponding to the terminal being changed dynamically, sending the configuration information to the terminal.

In an embodiment of the disclosure, when the TRP cluster corresponding to the terminal is subjected to the cluster handover, the configuration information includes at least one of:
a cluster Identity (ID) of a TRP cluster after handover;
a TRP ID of a TRP included in the TRP cluster after handover;
a Quasi Co-location (QCL) relationship between antenna ports in the TRP cluster after handover;
reference signal configuration information corresponding to the TRP included in the TRP cluster after handover;
radio resource information corresponding to the TRP included in the TRP cluster after handover; or
first beam indication information, in which the first beam indication information indicates beams of uplink and downlink service channels of a TRP that provides a communication service for the terminal in the TRP cluster after handover.

In an embodiment of the disclosure, when the TRP included in the TRP cluster corresponding to the terminal is changed dynamically, the configuration information includes at least one of:
a cluster ID of the TRP cluster corresponding to the terminal;
a TRP ID of the TRP that has been changed;
a QCL relationship between antenna ports in the TRP cluster after the dynamic change;
reference signal configuration information corresponding to the TRP that has been changed;
radio resource information corresponding to the TRP that has been changed; or
second beam indication information, in which the second beam indication information indicates beams of uplink and downlink service channels of a TRP that provides a communication service for the terminal in the TRP that has been changed.

In an embodiment of the disclosure, the radio resource information includes at least one of:
a radio resource frequency band;
a radio resource frequency point;
a radio resource bandwidth; or
a radio resource usage time.

In an embodiment of the disclosure, the first beam indication information or the second beam indication information includes at least one of:
a beam index; or
a TCI state ID.

In an embodiment of the disclosure, the network device includes at least one of:
a TRP;
a centralized unit; or
a core network device.

FIG. 7 is a structural schematic diagram of another communication apparatus provided by an embodiment of the disclosure. As illustrated in FIG. 7, the apparatus includes:
a transceiver module, configured to receive configuration information sent by a network device, in which the configuration information includes information associated with a TRP cluster corresponding to the terminal.

In conclusion, in the communication apparatus provided by the embodiment of the disclosure, the configuration information sent by the network device to the terminal includes information associated with the TRP cluster corresponding to the terminal, so that the terminal can successfully communicate with the TRP cluster corresponding to the terminal based on the configuration information to complete certain services, thereby ensuring the communication stability.

In the disclosure, the network device sends the configuration information to the terminal when the TRP cluster corresponding to the terminal is subjected to the cluster handover, or the network device sends the configuration information to the terminal when a TRP included in the TRP cluster corresponding to the terminal is changed dynamically. Therefore, in the disclosure, the TRP cluster corresponding to the terminal may be subjected to the cluster handover, or the TRP included in the TRP cluster corresponding to the terminal may be changed dynamically. Through performing handover for the TRP cluster corresponding to the terminal in real time or changing the TRP in the TRP cluster corresponding to the terminal in real time, the network device can always select the TRP being most beneficial (i.e., having better communication quality) for the terminal to provide communication services for the terminal, thus ensuring the communication quality. Moreover, in the disclosure, the TRP cluster corresponding to the terminal can be subjected to the cluster handover, or the TRP included in the TRP cluster corresponding to the terminal can be changed dynamically. When the terminal moves, the network device can still realize real-time communication with the terminal by performing handover for the TRP cluster corresponding to the terminal, or by dynamically changing the TRP in the TRP cluster corresponding to the terminal, without frequent cell handovers. This solves the problem of disconnection due to the frequent cell handovers, thereby ensuring the communication stability.

In an embodiment of the disclosure, receiving the configuration information sent by the network device includes at least one of:
in response to the TRP cluster corresponding to the terminal being subjected to the cluster handover, receiving the configuration information sent by the network device; or
in response to a TRP included in the TRP cluster corresponding to the terminal is changed dynamically, receiving the configuration information sent by the network device.

In an embodiment of the disclosure, when the TRP cluster corresponding to the terminal is subjected to the cluster handover, the configuration information includes at least one of:
a cluster ID of a TRP cluster after handover corresponding to the terminal;
a TRP ID of a TRP included in the TRP cluster after handover corresponding to the terminal;
a QCL relationship between antenna ports in the TRP cluster after handover corresponding to the terminal;
reference signal configuration information corresponding to the TRP included in the TRP cluster after handover corresponding to the terminal;
radio resource information corresponding to the TRP included in the TRP cluster after handover corresponding to the terminal; or
first beam indication information, in which the first beam indication information indicates beams of uplink and downlink service channels of a TRP that provides a communication service for the terminal in the TRP cluster after handover corresponding to the terminal.

In an embodiment of the disclosure, when the TRP included in the TRP cluster corresponding to the terminal is changed dynamically, the configuration information includes at least one of:
a cluster ID of the TRP cluster corresponding to the terminal;
a TRP ID of the TRP that has been changed in the TRP cluster corresponding to the terminal;
a QCL relationship between antenna ports in the TRP cluster after the dynamic change;
reference signal configuration information corresponding to the TRP that has been changed in the TRP cluster corresponding to the terminal;
radio resource information corresponding to the TRP that has been changed in the TRP cluster corresponding to the terminal; or
second beam indication information, in which the second beam indication information indicates beams of uplink and downlink service channels of a TRP that provides a communication service for the terminal in the TRP that has been changed in the TRP cluster corresponding to the terminal.

In an embodiment of the disclosure, the radio resource information includes at least one of:
a radio resource frequency band;
a radio resource frequency point;
a radio resource bandwidth; or
a radio resource usage time.

In an embodiment of the disclosure, the first beam indication information or the second beam indication information includes at least one of:
a beam index; or
a TCI state ID.

In an embodiment of the disclosure, the method further includes:
receiving a reference signal sent by a TRP;
obtaining a measurement result by measuring the reference signal; and
reporting the measurement result.

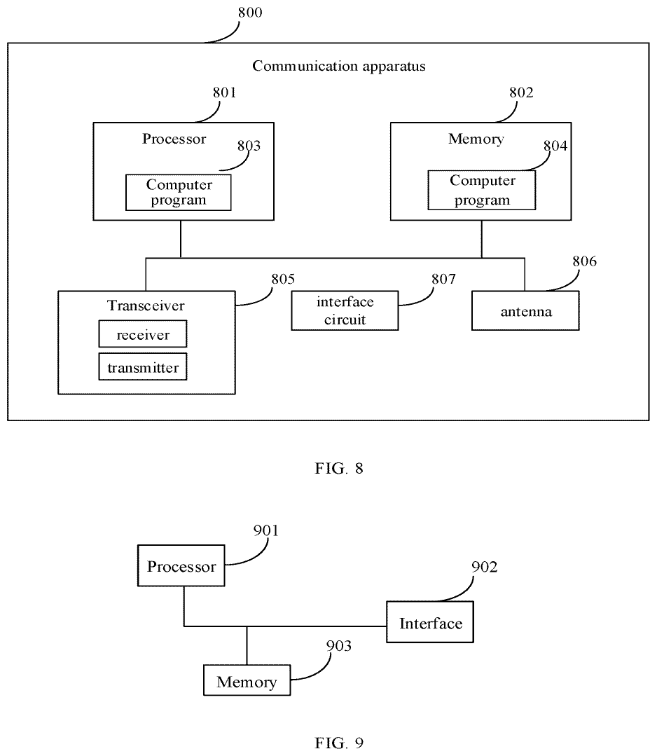

FIG. 8 is a structural schematic diagram of a communication apparatus 800 provided by an embodiment of the disclosure. The communication apparatus may be used to implement the methods described in the above-mentioned method embodiments, and details can be refer to the description in the above-mentioned method embodiments.

The communication apparatus 800 may include one or more processors 801. The processor 801 may be a general purpose processor or a dedicated processor, such as, a baseband processor or a central processor. The baseband processor is used for processing communication protocols and communication data. The central processor is used for controlling the communication apparatus 800 (e.g., base station, baseband chip, terminal, terminal chip, CU or DU), executing computer programs, and processing data of the computer programs.

In an embodiment of the disclosure, the communication apparatus 800 may further include one or more memories 802 on which a computer program 804 may be stored. When the processor 801 executes the computer program 804, the communication apparatus 800 is caused to perform the methods described in the above method embodiments. In an embodiment of the disclosure, the memory 802 may also be used to store data. The communication apparatus 800 and the memory 802 may be provided separately or may be integrated together.

In an embodiment of the disclosure, the communication apparatus 800 may also include a transceiver 805 and an antenna 806. The transceiver 805 may be referred to as transceiver unit, transceiver machine or transceiver circuit, for realizing a transceiver function. The transceiver 805 may include a receiver and a transmitter. The receiver may be referred to as receiver machine or receiving circuit, for realizing a receiving function. The transmitter may be referred to as transmitter machine or transmitting circuit, for realizing a transmitting function.

In an embodiment of the disclosure, the communication apparatus 800 may also include one or more interface circuits 807. The interface circuits 807 are used to receive code instructions and transmit them to the processor 801. The processor 801 runs the code instructions to cause the communication apparatus 800 to perform the methods described in the method embodiments.

In an implementation, the processor 801 may include a transceiver for implementing the receiving and transmitting functions. The transceiver may be, for example, a transceiver circuit, an interface or an interface circuit. The transceiver circuit, interface or interface circuit for implementing the receiving and transmitting functions may be separated or may be integrated together. The transceiver circuit, interface or interface circuit described above may be used for code/data reading and writing, or may be used for signal transmission or delivery.

In an implementation, the processor 801 may store a computer program 803 that can be executed by the processor 801 and may cause the communication apparatus 800 to perform the methods described in the method embodiments above. The computer program 803 may be solidified in the processor 801, in which case the processor 801 may be implemented by hardware.

In an implementation, the communication apparatus 800 may include circuits. The circuits may implement the sending, receiving or communicating function in the preceding method embodiments. The processor and the transceiver described in the disclosure may be implemented on integrated circuits (ICs), analog ICs, radio frequency ICs (RFICs), mixed signal ICs, application specific ICs (ASICs), printed circuit boards (PCBs) and electronic devices. The processor and the transceiver may also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The structure of the communication apparatus in the above embodiment is not limited by FIG. 8. The communication apparatus may be a stand-alone device or may be part of a larger device. For example, the communication apparatus may be:
(1) a stand-alone IC, chip, chip system or subsystem;
(2) a collection of ICs including one or more ICs, in an embodiment of the disclosure, the collection of ICs may also include storage components for storing data and computer programs;
(3) an ASIC, such as a modem;
(4) modules that can be embedded within other devices;
(5) receivers, terminals, smart terminals, cellular phones, wireless devices, handheld machines, mobile units, in-vehicle devices, network devices, cloud devices, artificial intelligence devices, and the like; and
(6) others.

The case where the communication apparatus is a chip may be referred to the structural schematic diagram of a chip shown in FIG. 9. In FIG. 9, the chip includes a processor 901 and an interface 902. There may be one or more processors 901, and there may be a plurality of interfaces 902.

In an embodiment of the disclosure, the chip also includes a memory 903 for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

The disclosure also provides a non-transitory computer-readable storage medium having an instruction stored thereon. When the instruction is executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a non-transitory computer-readable storage medium or transmitted from one non-transitory computer-readable storage medium to another non-transitory computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or wirelessly (e.g., by using infrared wave, wireless wave, or microwave). The non-transitory computer-readable storage medium may be any usable medium to which the computer has access or a data storage device integrated by one or more usable mediums such as a server or a data center. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second” and other numerical numbers involved in the disclosure are only used for the convenience of differentiation, and are not used to limit the scope of the embodiments of the disclosure, or indicate the order of precedence.

The term “at least one” in the disclosure may also be described as one or more, and the term “multiple” may be two, three, four or more, which is not limited in the disclosure. In the embodiment of the disclosure, for a type of technical features, “first”, “second” and “third”, and “A”, “B”, “C” and “D” are used to distinguish different technical features of the type, the technical features described using the terms “first”, “second” and “third”, and “A”, “B”, “C” and “D” do not indicate any order of precedence or magnitude.

The correspondences shown in the tables in the disclosure may be configured or predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in the disclosure may not be configured. As another example, the above tables may be adjusted appropriately, such as splitting, combining, and the like. The names of the parameters shown in the titles of the above tables may be other names that may be understood by the communication apparatus, and the values or representations of the parameters may be other values or representations that are understood by the communication apparatus. Each of the above tables may also be implemented by other data structures, such as, arrays, queues, containers, stacks, linear tables, pointers, chained lists, trees, graphs, structures, classes, heaps, and Hash tables.

The term “predefine” in the disclosure may be understood as define, pre-define, store, pre-store, pre-negotiate, pre-configure, solidify, or pre-fire.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above may be referred to the corresponding processes in the preceding method embodiments, and will not be repeated herein.

The above are only specific implementations of the disclosure, but the scope of protection of the disclosure is not limited thereto. Those skilled in the art familiar to this technical field may easily think of changes or substitutions in the technical scope disclosed by the disclosure, which shall be covered by the scope of protection of the disclosure. Therefore, the scope of protection of the disclosure shall be governed by the scope of protection of the attached claims.

1. A method for configuring a communication system, performed by a network device, comprising:
sending configuration information to a terminal, wherein the configuration information comprises information associated with a transmission reception point (TRP) cluster corresponding to the terminal.

2. The method of claim 1, wherein sending the configuration information to the terminal comprises at least one of:
in response to the TRP cluster corresponding to the terminal being subjected to a handover, sending the configuration information to the terminal; or
in response to a TRP comprised in the TRP cluster corresponding to the terminal being changed, sending the configuration information to the terminal.

3. The method of claim 2, wherein in response to the TRP cluster corresponding to the terminal being subjected to the handover, the configuration information comprises at least one of:
a cluster Identity (ID) of a TRP cluster after handover;
a TRP ID of a TRP comprised in the TRP cluster after handover;
a Quasi Co-location (QCL) relationship between antenna ports in the TRP cluster after handover;
reference signal configuration information corresponding to the TRP comprised in the TRP cluster after handover;
radio resource information corresponding to the TRP comprised in the TRP cluster after handover; or
first beam indication information, wherein the first beam indication information indicates beams of uplink and downlink service channels of a TRP that provides a communication service for the terminal in the TRP cluster after handover.

4. The method of claim 2, wherein in response to the TRP comprised in the TRP cluster corresponding to the terminal being changed, the configuration information comprises at least one of:
a cluster ID of the TRP cluster corresponding to the terminal;
a TRP ID of the TRP that has been changed;
a QCL relationship between antenna ports in the TRP cluster after the dynamic change;
reference signal configuration information corresponding to the TRP that has been changed;
radio resource information corresponding to the TRP that has been changed; or
second beam indication information, wherein the second beam indication information indicates beams of uplink and downlink service channels of a TRP that provides a communication service for the terminal in the TRP that has been changed.

5. The method of claim wherein the radio resource information comprises at least one of:
a radio resource frequency band;
a radio resource frequency point;
a radio resource bandwidth; or
a radio resource usage time,
or wherein the first beam indication information comprises at least one of:
a beam index; or
a Transmission Configuration Indicator (TCI) state ID.

6. The method of claim 4, wherein the radio resource information comprises at least one of:
a radio resource frequency band;
a radio resource frequency point;
a radio resource bandwidth; or
a radio resource usage time,
or wherein the second beam indication information comprises at least one of:
a beam index; or
a state ID.

7. The method of claim 1, wherein the network device comprises at least one of:
a TRP;
a centralized unit (CU); or
a core network device.

8. A method for configuring a communication system, performed by a terminal, comprising:
receiving configuration information sent by a network device, wherein the configuration information comprises information associated with a transmission reception point (TRP) cluster corresponding to the terminal.

9. The method of claim 8, wherein receiving the configuration information sent by the network device comprises at least one of:
in response to the TRP cluster corresponding to the terminal being subjected to a handover, receiving the configuration information sent by the network device; or in response to a TRP comprised in the TRP cluster corresponding to the terminal being changed receiving the configuration information sent by the network device.

10. The method of claim 8, wherein in response to the TRP cluster corresponding to the terminal being subjected to the cluster handover, the configuration information comprises at least one of:
a cluster Identity (ID) of a TRP cluster after handover corresponding to the terminal;
a TRP ID of a TRP comprised in the TRP cluster after handover corresponding to the terminal;
a Quasi Co-location (QCL) relationship between antenna ports in the TRP cluster after handover corresponding to the terminal;
reference signal configuration information corresponding to the TRP comprised in the TRP cluster after handover corresponding to the terminal;
radio resource information corresponding to the TRP comprised in the TRP cluster after handover corresponding to the terminal; or
first beam indication information, wherein the first beam indication information indicates beams of uplink and downlink service channels of a TRP that provides a communication service for the terminal in the TRP cluster after handover corresponding to the terminal.

11. The method of claim 8, wherein in response to the TRP comprised in the TRP cluster corresponding to the terminal being changed the configuration information comprises at least one of:
a cluster ID of the TRP cluster corresponding to the terminal;
a TRP ID of the TRP that has been changed in the TRP cluster corresponding to the terminal;
a QCL relationship between antenna ports in the TRP cluster after the dynamic change;
reference signal configuration information corresponding to the TRP that has been changed in the TRP cluster corresponding to the terminal;
radio resource information corresponding to the TRP that has been changed in the TRP cluster corresponding to the terminal; or
second beam indication information, wherein the second beam indication information indicates beams of uplink and downlink service channels of a TRP that provides a communication service for the terminal in the TRP that has been changed in the TRP cluster corresponding to the terminal.

12. The method of claim 10 wherein the radio resource information comprises at least one of:
a radio resource frequency band;
a radio resource frequency point;
a radio resource bandwidth; or
a radio resource usage time,
or wherein the first beam indication information comprises at least one of:
a beam index; or
a Transmission Configuration Indicator (TCI) state ID.

13. The method of claim 11, wherein the radio resource information comprises at least one of:
a radio resource frequency band;
a radio resource frequency point;
a radio resource bandwidth; or
a radio resource usage time,
or wherein the second beam indication information comprises at least one of:
a beam index; or
TCI state ID.

14. The method of claim 8, further comprising:
receiving a reference signal sent by a TRP;
obtaining a measurement result by measuring the reference signal; and
reporting the measurement result.

15. (canceled)

16. (canceled)

17. A network device, comprising:
a processor; and
a memory storing a computer program executable by the processor,
wherein the processor is configured to:
send configuration information to a terminal, wherein the configuration information comprises information associated with a transmission reception point (TRP) cluster corresponding to the terminal.

18. A terminal, comprising:
a processor; and
a memory storing a computer program executable by the processor,
wherein the processor is configured to perform the method of claim 8.

19. (canceled)

20. The network device of claim 17, wherein the processor is further configured to perform at least one of:
in response to the TRP cluster corresponding to the terminal being subjected to a handover, sending the configuration information to the terminal; or
in response to a TRP comprised in the TRP cluster corresponding to the terminal being changed, sending the configuration information to the terminal.

21. The network device of claim 20, wherein in response to the TRP cluster corresponding to the terminal being subjected to the handover, the configuration information comprises at least one of:
a cluster Identity (ID) of a TRP cluster after handover;
a TRP ID of a TRP comprised in the TRP cluster after handover;
a Quasi Co-location (QCL) relationship between antenna ports in the TRP cluster after handover;
reference signal configuration information corresponding to the TRP comprised in the TRP cluster after handover;
radio resource information corresponding to the TRP comprised in the TRP cluster after handover; or
first beam indication information, wherein the first beam indication information indicates beams of uplink and downlink service channels of a TRP that provides a communication service for the terminal in the TRP cluster after handover; or
wherein in response to the TRP comprised in the TRP cluster corresponding to the terminal being changed, the configuration information comprises at least one of:
a cluster ID of the TRP cluster corresponding to the terminal;
a TRP ID of the TRP that has been changed;
a QCL relationship between antenna ports in the TRP cluster after the dynamic change;
reference signal configuration information corresponding to the TRP that has been changed;
radio resource information corresponding to the TRP that has been changed; or
second beam indication information, wherein the second beam indication information indicates beams of uplink and downlink service channels of a TRP that provides a communication service for the terminal in the TRP that has been changed.

22. The network device of claim 21, wherein the radio resource information comprises at least one of:
a radio resource frequency band;
a radio resource frequency point;
a radio resource bandwidth; or
a radio resource usage time,
or wherein the first beam indication information or the second beam indication information comprises at least one of:
a beam index; or
a Transmission Configuration Indicator (TCI) state ID.

23. The network device of claim 17, wherein the network device comprises at least one of:
a TRP;
a centralized unit (CU); or
a core network device.
